(19) United States
(12) Patent Application Publication
(10) Pub. No.: US 2018/0108053 A1
(43) Pub. Date: Apr. 19, 2018

(54) COMPUTER SYSTEM FOR CALCULATING TRANSLATION COSTS

(71) Applicant: RWS TRANSLATIONS LTD, Chalfont St Peter Buckinghamshire (GB)

(72) Inventors: Neil Thomas SIMPKIN, Chalfont St Peter Buckinghamshire (GB); Charles Edward SITCH, Stoke Mandeville Buckinghamshire (GB); Hugh Alexander BIERRUM, Amersham Buckinghamshire (GB); Sasmita RAY, Homebush West, New South Wales (AU); Senthil Kumar SARANGAPANI, Girraween, New South Wales (AU); John Wilfred SELVARAJ, Girraween, New South Wales (AU); Benjamin Leslie COOMBES, London Greater London (GB); Ben John CURLEY, Como, New South Wales (AU); Justin Ryan SIMPSON, Newport, New South Wales (AU)

(73) Assignee: RWS TRANSLATIONS LTD, Chalfont St Peter Buckinghamshire (GB)

(21) Appl. No.: 15/560,668

(22) PCT Filed: Mar. 24, 2016
(86) PCT No.: PCT/GB2016/050844

§ 371 Date: Sep. 22, 2017

(30) Foreign Application Priority Data
Mar. 25, 2015 (GB) 1505079.2

(51) Int. Cl. G06Q 30/02; G06F 17/28; G06K 9/00; G06Q 50/18

(52) U.S. Cl. CPC G06Q 30/0283; G06F 17/289; G06F 17/2715; G06Q 50/184; G06K 9/00483

(57) ABSTRACT

The present disclosure relates to a computer system, computer program product and computer implemented method for automatically calculating translation costs based upon translation memory analysis. This involves receiving an original document and a source-target language pair, comparing the original document with previously translated text or the translation memory database corresponding to the source-target language pair and computing a modified word count reflecting the degree of overlap between the original document and the previously translated text based on the comparison. Further, a per word translation rate corresponding to the source-target language pair is identified in a viewable database and a modified translation cost is calculated from the per translation rate and the modified word count.

### FIELD OF THE INVENTION

The present invention relates to a computer system for calculating translation costs based upon translation memory analysis.

The invention has been developed specifically for calculating the translation costs of patent specifications, in particular where the filing of multiple applications are required, and will be described below with reference to that application. However, it will be appreciated that it is not limited to that particular use, and is also suitable for estimating the cost of translating other documents into one or more languages.

### BACKGROUND

Current methods of generating cost estimates and preparing invoices for patent translations are generally very manual processes. An applicant decides which countries they wish to file into and will typically ask his, her or its local attorney how much it will cost to file their proposed patent application into those countries. The attorney then manually produces a general cost estimate based upon an average cost of previously filed cases or simply obtains fresh estimates for the proposed applications directly from attorneys or agents practicing in the countries of interest to the applicant. However, such estimates are generally very inaccurate, particularly with regard to the translation costs involved.

One of the most significant components in the foreign filing cost is the translation cost. The patent offices in different countries require the patent specifications to be translated into their local languages. When specifications are particularly long the translation costs can be significant.

A number of specialist translation companies exist. They typically make use of individual specialist translators who are skilled in a particular language to translate patent specifications for clients.

Some companies store previously translated documents as a “translation memory.” In particular, translation memories store pairs of sentences which have previously been translated from a source language into a target language. When a translator comes across a sentence in a source document that wholly or partly matches a first sentence of the sentence pair, the software prompts the translator to consider adopting the second sentence in the target language. If the translation looks acceptable, the job of the translator is made easier in that he may concentrate his translation efforts on sentences which haven't previously been translated. Typically such translation memory software “learns” from each translation, storing each new sentence pair in the expanding translation memory.

One disadvantage of such prior art methods is that estimates which are based upon average costs are highly inaccurate. In most countries, translation costs vary according to the size of the patent specification. As such, while an average cost is relatively administratively convenient to calculate, it can often be inaccurate, making it less than ideal for budgeting purposes.

If the attorney chooses to obtain a more accurate cost estimate that is specific to the proposed application or applications, this will involve considerable time and effort to achieve with any real degree of accuracy. For example, if an applicant asks for a cost estimate in multiple countries, the attorney has to write to all of his/her foreign attorneys to request the estimates, then receive and compile them in the local currency for the applicant. This administrative effort is incurred by both the local attorney and the foreign attorneys. Alternatively, the local attorney needs to manually go through a schedule of charges for each foreign attorney and try to generate a cost estimate from those numbers. This process takes a long time, which the local attorney would likely preferentially spend on higher level matters. The time involved can also negatively affect the client, especially where deadlines are looming for having the proposed application or applications filed.

A further disadvantage of prior art methods is that in order to generate an accurate cost estimate for a proposed foreign application, certain statistics or characteristics need to be known about the piece of industrial property. In the case of patents, for example, these statistics typically include the number of words in the associated patent specification, the number of pages in that specification, and the number of claims in that specification. This information is usually obtained by an administrator undertaking a manual count of the pages and other aspects of the specification to gather the required statistics. Following from this, the administrator will then manually multiply the gathered statistics by the respective amounts gained from fee schedules provided by foreign attorneys. The process of manually finding those pieces of data and accurately calculating a foreign patent filing is usually too onerous for most attorneys/administrators to thoroughly pursue and hence the accuracy of the cost estimate is compromised.

### SUMMARY

In a first aspect, there is provided a computer system for automatically calculating translation costs based upon translation memory analysis, the computer system comprising an interface adapted to communicate with a translation memory analyser and a fee calculation engine, wherein (a) the interface is configured to receive an original document and a source-target language pair; (b) the translation memory analyser is configured to (i) compare the original document with previously translated text portions in the language of the original document stored in a translation memory database corresponding to the source-target language pair; and (ii) return an original word count and a modified word count reflecting the degree of overlap between the original document and the previously translated text portions; (c) the fee calculation engine is configured to (i) receive at least the modified word count and the source-target language pair; (ii) identify a per word translation rate corresponding to the source-target language pair in a fee rule database; and (iii) calculate a modified translation cost from the per word translation rate and the modified word count.

Advantageously, by calculating a modified translation cost based on the modified word count, a more accurate estimate is enabled. For example, the interface may be configured to display the modified translation cost or to transmit the modified translation cost to a client computer.

The fee calculation engine may check whether the modified word count is lower than the original word count and if this check is negative, the fee calculation engine overrides the modified word count with the original word count. In this way, the presentation of erroneous results is prevented.

In some embodiments, the interface comprises a client-side interface, for example an app running in a browser. In some embodiments, the interface is provided server-side and may implement an Application Program Interface (API), a web service or an http content stream. In some embodiments, the interface comprises a distributed arrangement, for example interacting with a third party service (for example a cloud service) for storage and/or pre-processing of received data, but in some embodiments also to query databases, in particular the translation memory database and fee rule database, to process the retrieved data, route data between different components and/or generate the translation cost. The distributed arrangement may also or instead comprise a platform hosted by one or more servers (physical or virtual) to perform some or all of these functions and/or to interact with the third-party or cloud service, as the case may be.

It will be appreciated that while the interface, translation memory analyser and fee calculation engine are described herein as separate modules, this may in some embodiments be a logical distinction relating to the function of the respective modules and the modules in question may be implemented in any combination of shared hardware or software, third party service(s), API(s), web service(s), etc.

In some embodiments, the interface is configured to receive the source-target pair explicitly, for example from a user interface, where a user can enter a source and a target language. In other embodiments, the source-target pair is received implicitly, for example in the form of information from which the source-target pair can be derived. The information may include a selection of one or more countries in respect of which a user wishes to obtain translation cost, and receiving the source-target language pair may include deriving a respective target language from each of the one or more countries. Target languages (or countries) may be stored in association with a user identifier and retrieved using a received user identifier in order to receive the source-target language pair. Receiving the source-target language pair may include receiving information from which the source language can be derived. For example, the source language may be derived from metadata associated with (embedded in or stored in association with) the original document or an identifier of the original document (e.g. the publication number of a patent application). The source language may of course be received from an explicit user input of the source language, in some embodiments.

In some embodiments, the interface is configured to receive a plurality of selected source-target language pairs and a modified word count and translation cost is produced for each language pair. For example, the original document may be a patent specification and each language pair may correspond to a selected patent jurisdiction. Additionally, the fee calculation engine may further be configured to calculate attorney fees and government fees for filing the patent specification in the selected patent jurisdiction. Each language pair maybe selected automatically on the basis of the selected patent jurisdiction. Patent jurisdictions may be received from a user or, alternatively, a list of preselected patent jurisdictions may be stored in a user preference database.

In some embodiments, the interface is adapted to receive a user identifier, for example the same user identifier mentioned above. The translation memory database contains a plurality of translation memories in these embodiments, each having an associated user identifier. When the translation memory analyser compares the original document with previously translated text portions stored in the translation memory database, it does so only in respect of those translation memories that are associated with the received user identifier.

Advantageously, by making the translation memory comparison only with translation memories associated with a user identifier, the analysis is limited to translation memories that are more likely to be relevant to the text at hand, because they are associated with the same user. Accordingly, the processing load associated with this analysis can be reduced by carrying out a more targeted analysis. For example, the time taken to search for matching translation memories can be drastically reduced in this fashion.

In a further aspect, there is provided a computer implemented method of automatically calculating translation costs based upon translation memory analysis, the method comprising receiving an original document and a source-target language pair; comparing the original document with previously translated text portions in the language of the original document stored in a translation memory database corresponding to the source-target language pair; computing a modified word count reflecting the degree of overlap between the original document and the previously translated text portions based on the comparison; identifying a per word translation rate corresponding to the source-target language pair in a fee rule database; and calculating a modified translation cost from the per word translation rate and the modified word count.

Further aspects provide a computer program product, a tangible computer readable medium embodying such a computer program product, a carrier signal encoding such a computer program product and a computer system, all for implementing a method as set out above and further detailed in the dependent method claims which are listed below.

In some embodiments of any of these aspects, a terminology database is provided in addition to the translation memory database. The terminology database serves a similar purpose as the translation memory database but rather than being based on historic translations, it contains pre-defined source-target language text pairs of terminology (words, phrases . . . ) to be used in the translation. In these embodiments, calculating a translation cost and/or estimating word counts comprises querying both translation memory and terminology databases, combining the results with suitable logic (e.g. translation pairs in the terminology database overriding translation pairs in the translation memory database) and estimating cost/corrected word count in a fashion analogous to embodiments where a terminology database is not used (for example, reducing word count if a match is found in either database). A plurality of terminology databases may be provided, each associated with a user identifier (or association with a user identifier may be on a per record or table basis), so that corrected word count/cost are based on a customised terminology database in a fashion analogous to the plurality of translation memories of embodiments described above.

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description which follow are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels.

Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or input and display devices.

Embodiments may be in hardware, such as implemented to operate on a device or combination of devices, for example, whereas other embodiments may be in software. Embodiments may be implemented in firmware, or as any combination of hardware, software, and/or firmware, for example. Likewise, although claimed subject matter is not limited in scope in this respect, embodiments may comprise one or more articles, such as a carrier or storage medium or storage media. The storage media, such as, one or more CD-ROMs, solid state memory, magneto-optical disk and/or magnetic disks or tapes, for example, may have stored thereon instructions, that when executed by a system, such as a computer system, computing platform, or other system, for example, may result in an embodiment of a method in accordance with claimed subject matter being executed, such as one of the embodiments previously described, for example. Embodiments may comprise a carrier signal on a telecommunications medium, for example a telecommunications network. Examples of suitable carrier signals include a radio frequency signal, an optical signal, and/or an electronic signal.

As one potential example, a computing platform or computer system may include one or more processing units or processors, one or more input/output devices, such as a display, a keyboard and/or a mouse, and/or one or more memories, such as static random access memory, dynamic random access memory, flash memory, and/or a hard drive.

For the avoidance of doubt, it is understood that references to a computer, computer system or a computer platform or apparatus are not intended to be limited to a single physical entity or piece of equipment but equally include a distributed computer system, for example of networked components.

### BRIEF DESCRIPTION OF THE DRAWINGS

Embodiments will now be described, by way of example only, with reference to the accompanying drawings in which:

FIG. 1A,1B and 1C are block diagrams of computer systems for automatically calculating translation costs based upon translation memory analysis;

FIG. 2 is a flow diagram illustrating a process of generating a modified word count based upon translation memory;

FIG. 3 is a flow diagram illustrating a process of calculating translation costs based upon the modified word count;

FIG. 4 is a screen shot of an interface for displaying translation costs;

FIG. 5 is an example web services request to generate a modified word count;

FIG. 6 is an example web services response, returning a number of modified word counts; and

FIG. 7 is a screen shot of an example interface reporting the returned modified word counts for a plurality of language pairs.

### DETAILED DESCRIPTION OF THE PREFERRED EMBODIMENTS

In the description and claims use is made of the term “country” to indicate a jurisdiction to which an intellectual property right, or an application for an intellectual property right, pertains. It will be appreciated that, unless the context clearly indicates otherwise, this term country is intended to also cover “region” or multiple countries if such an intellectual property right has a nature which extends or applies to such a region or countries.

In the description and claims the terms “intellectual property” and “industrial property” are used interchangeably and both are abbreviated with the term “IP”.

In the description and claims use is made of the term “patent specification” to indicate a document to be translated into a variety of languages. It will be appreciated that, unless the context clearly indicates otherwise, this term is intended to also cover any document to be translated into one or more languages and for which an automated translation fee should be calculated.

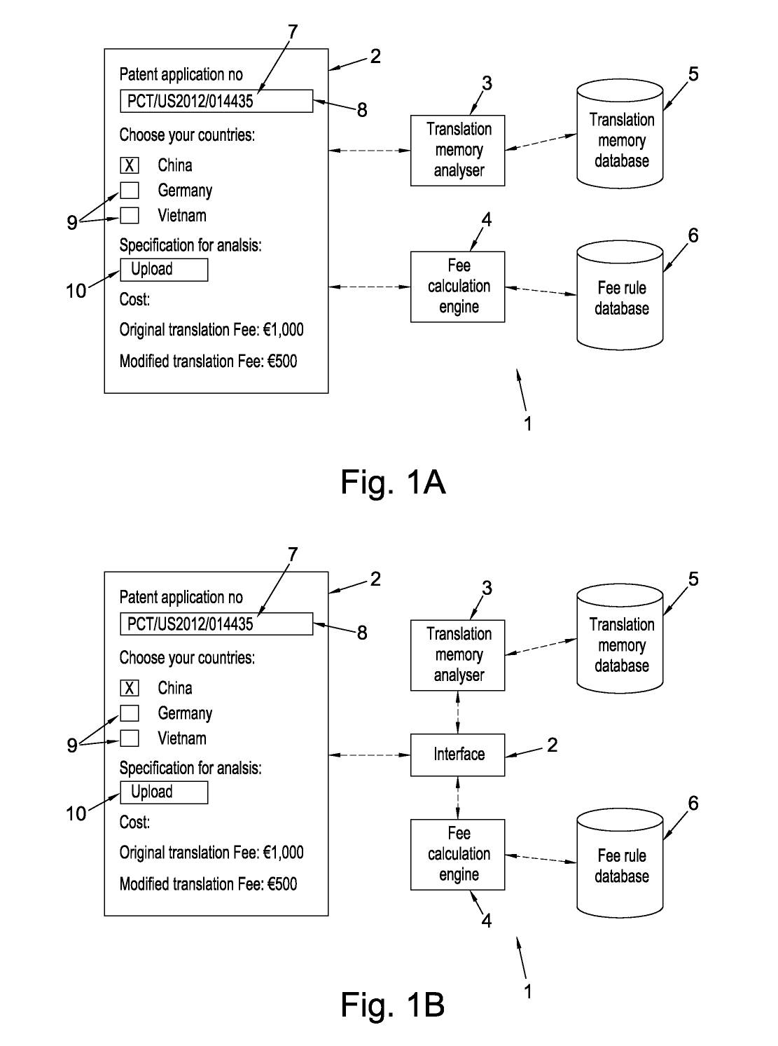

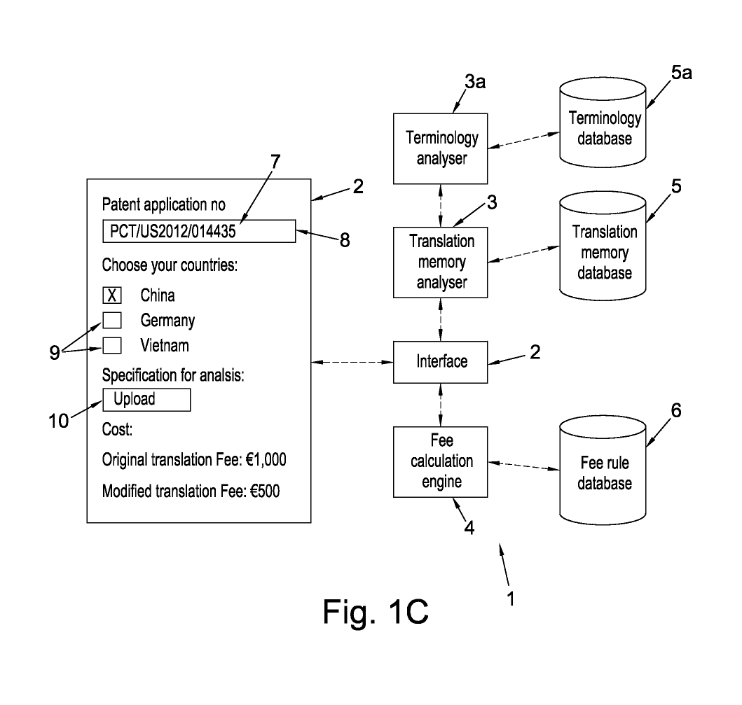

With reference to FIG. 1A, a computer system 1 for automatically calculating translation costs based upon translation memory analysis includes an interface 2 adapted to communicate with a translation memory analyser 3 and a fee calculation engine 4. The translation memory analyser 3 is in communication with a translation memory database 5 which stores a number of previous translations (not shown). The previous translations each comprise a pair of text portions (e.g. sentences) in the source language and the target language corresponding to the source-target language pair or pairs in some embodiments. In some embodiments, where the translation memory database is maintained for cost-estimate purposes only, only the source language text portions may be stored, as this may be sufficient for comparison purposes. The fee calculation engine 4 is in communication with a fee rule database 6 which stores a number of fee rules (not shown). Each fee rule includes the per-word translation rate of a particular source-target language pair, and preferably also includes rules relating to the patent filing fees payable to patent offices and the foreign patent attorneys responsible for those filings.

In a preferred embodiment, the interface 2 is designed to receive an IP identifier 7 via an identifier receiving field 8, along with a plurality of country selections via country selection fields 9.

The interface is implemented in a web browser on a client computer and the translation memory analyser 3 and fee calculation engine 4 is implemented on one or more server computers communicating with the client computer over a communications network, in some embodiments. In other embodiments, the interface 2 is local to the translation memory analysers and fee calculation engine 4.

With reference to FIG. 1B, in some embodiments, the interface 2 is implemented as a communication interface server side, for example on the same server as the translation memory analysers 3 and the fee calculation engine 4. The interface 2, in these embodiments, communicates with a web browser client side over a communications network, for example the internet, to cause the web browser to display a browser window 2a corresponding to the interface described above with reference to FIG. 1A.

With reference to FIG. 10, in some embodiments a terminology analyser 3a and terminology database 5a is present. The terminology analyser 3a operates on the terminology database 5a in a manner analogous to the translation memory analyser to determine automatic translations. The automatic translations may be combined in any suitable way, for example using all matches, with matches in the terminology database overriding those in the translation memory database. For the purpose of fee calculation, therefore, a reduced word count may be returned if either database provides a match. In some embodiments, the terminology analyser 3a is coupled to the translation memory analyser 3 to implement this functionality. In other embodiments, each analyser 3,3a connects separately to the interface 2 with the individual results combined there. In some embodiments, the functionality of both analysers 3,3a is incorporated in a single module, for example translation memory analyser 3 or interface 2.

The interface 2 may be implemented in a number of ways, for example as described above. In addition, in particular in the context of embodiments described above with reference to FIGS. 1B and 1C, the interface 2 may itself be implemented in a number of ways, for example as a platform hosted entirely on a server (physical or virtual), hosted or co-hosted on a platform comprising one or more servers (physical or virtual), on its own or together with other modules of the system, by a third party service used to provide storage and/or pre-processing of data received from a client computer where display of a user interface may be caused, or by a combination of these approaches.

More generally, it will be understood that all modules and functionalities, in particular the translation memory analyser 3 (terminology analyser 3a where applicable), the fee calculation engine 4, the interface 2 described above with reference to FIG. 1A to 1C, the translation memory database 5 (terminology database 5a where applicable) and the fee rule database 6, may correspond to actual physical implementations of these elements in respective processors and/or computers, or may correspond to functional blocks that may be implemented all on the same processor and/or computer system, or distributed between various processors and computer systems.

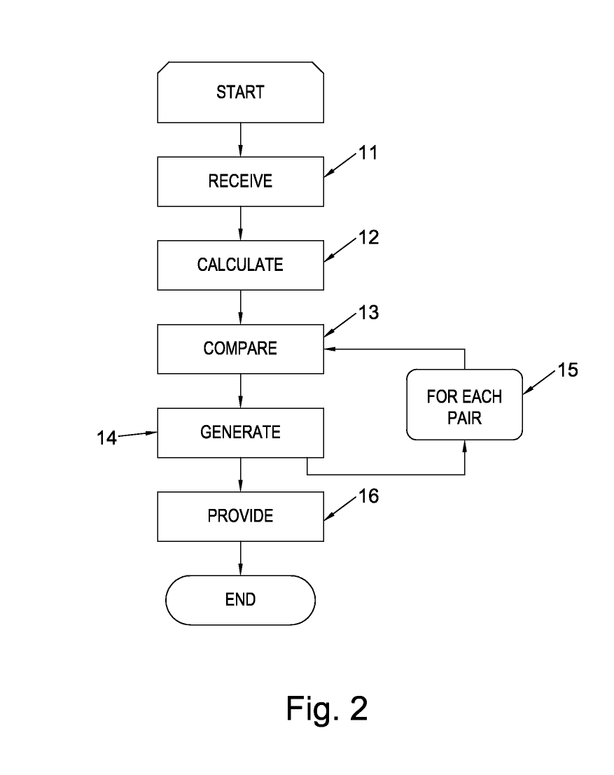

FIG. 2 illustrates the steps performed by the system to automatically calculate translation costs based upon translation memory analysis. The computer system 1 receives 11 an electronic copy of the patent specification (not shown). In one embodiment the computer system receives an electronic copy of the patent specification from a user via an upload section 10 of the interface. In an alternative embodiment the computer system 1 retrieves an electronic copy of the patent specification from an online database (not shown).

The system then calculates 12 an original word count, reflecting the number of words in the patent specification to be translated. The translation memory analyser 3 then compares 13 the specification with previous translations stored in the translation memory database 5 for a first language pair and generates 14 a modified word count for that language pair. The modified word count reflects the degree of overlap between the specification to be translated and previous translations. In embodiments that also have a terminology database and analyser functionality, as described above, the modified word count may reflect the degree of overlap with the translation memory and the extent to which terms and phrases in the source document are present in terminology database. The translation memory analyser 5 then repeats the analysis 15 for each language pair corresponding to the selected countries received via the country selection fields 9 (taking account of the terminology database, in embodiments where this is applicable) and provides 16 the original and modified word counts (for each pair) to the fee calculation engine 4.

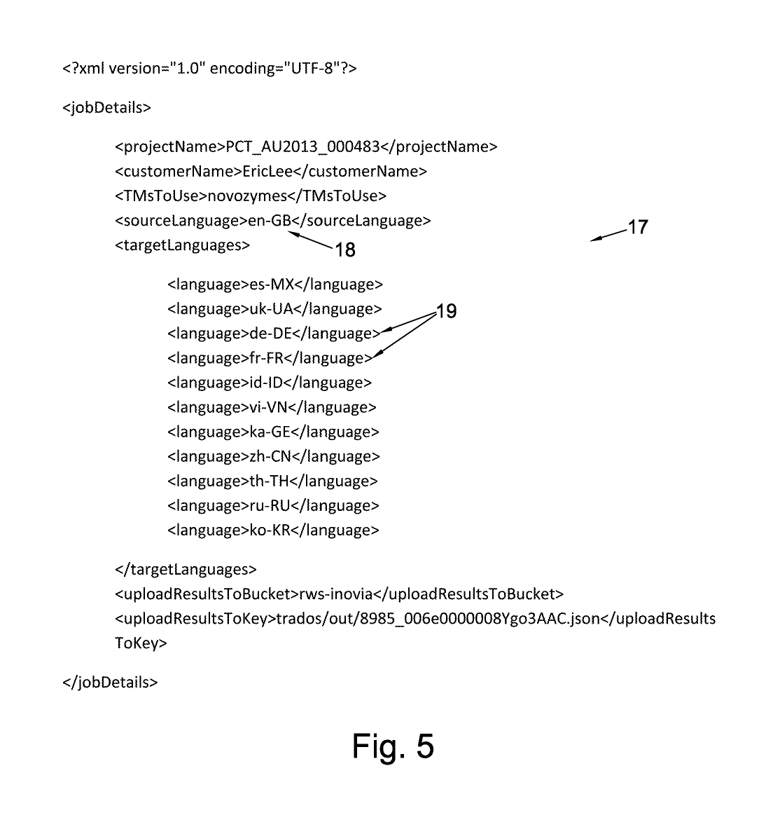

An example system request 17 for modified word counts in a plurality of language pairs is illustrated in FIG. 5. In this example the source language 18 is English (“en-GB) and there are eleven target languages 19. Each target language includes a reference to the language to be translated and the country the patent specification is to be filed in. For example “ko-KR” means that the specification is to be translated into Korean and is to be filed into South Korea. “es-MX” means that the specification is to be translated into Spanish and is to be filed into Mexico.

In one embodiment, the language to be translated is determined automatically on the basis of the selected country. For example, the selection of South Korea at country selection field 9 allows automatic determination that the language to be translated into is Korean.

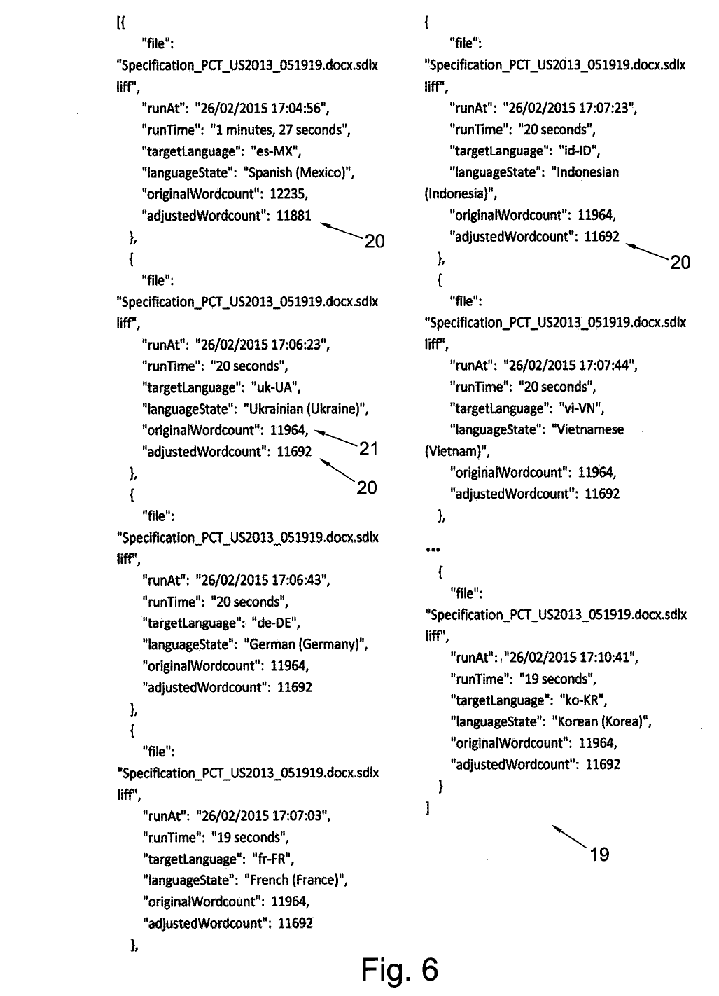

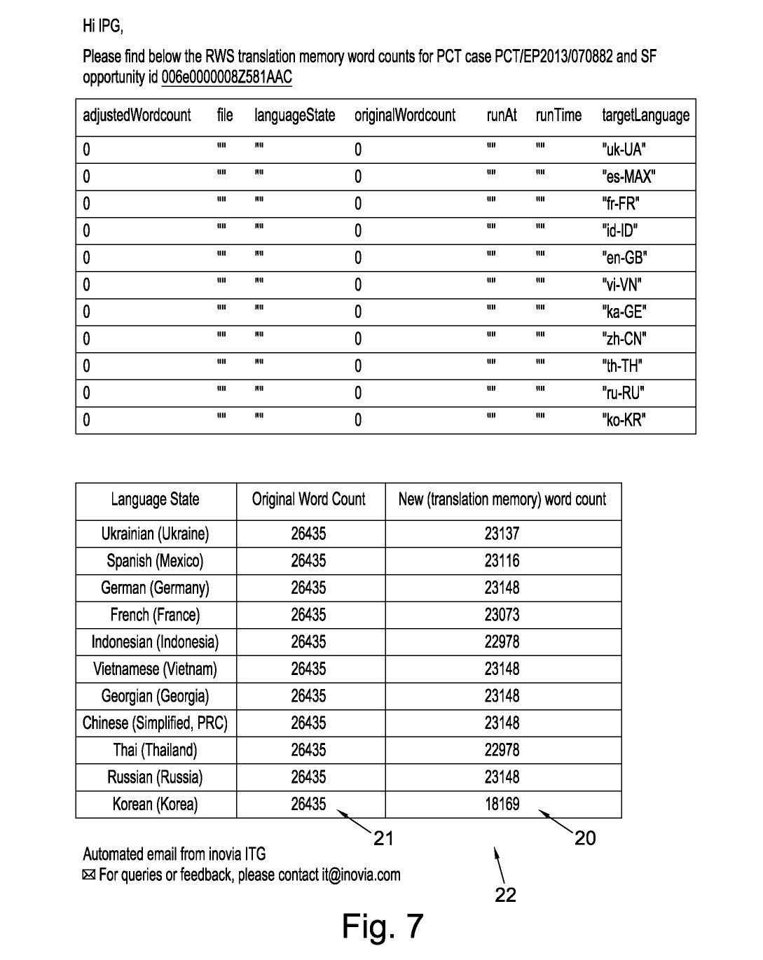

FIG. 6 illustrates an example web services response 19, returning a number of modified word counts 20 according to an embodiment of the invention. As shown, for this particular PCT specification the original word count 21 was 11,964 but based upon the translation memory for English to Ukrainian, the modified word count 20 for that language pair was 11,692.

By way of further illustration, when generating the original and modified word counts the system also generates a reporting email 22 which shows the original 21 and modified word counts 20 for each language pair in some embodiments.

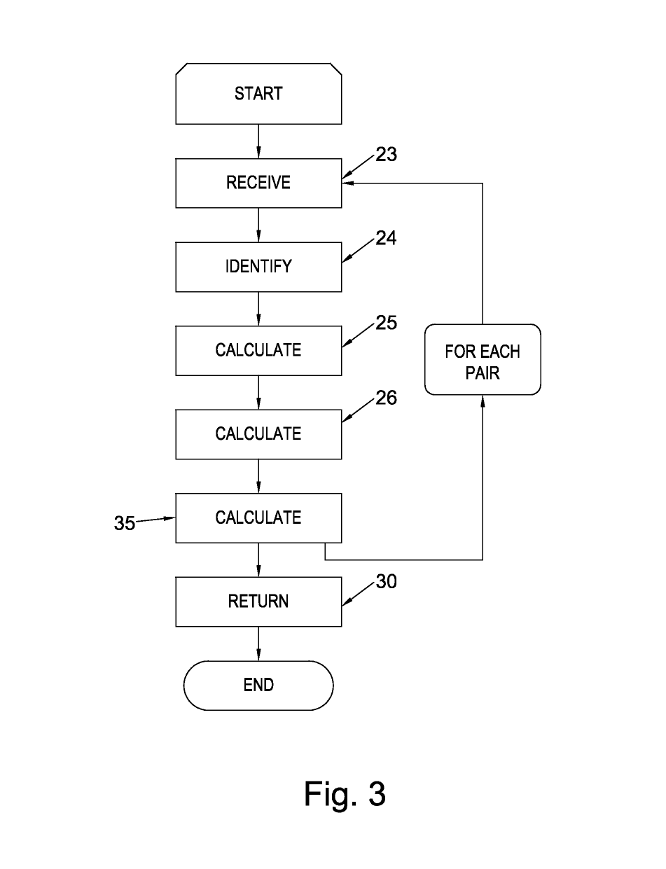

Turning now to FIG. 3, once the original 21 and modified 20 word counts have been generated for each language pair by the translation memory analyser (in some embodiments in conjunction with the terminology analyser), the fee calculation engine 4 receives 23 a modified word count 20 and a first source-target language pair. It then identifies 24 a per word translation rate corresponding to the first source-target language pair from the fee rule database 6 and calculates 25 an original translation fee 27 based upon the original word count 21 and the per word translation rate.

The fee calculation engine 4 then calculates 26 a modified translation fee 28 for that first language pair based upon the modified word count 20 and the per word translation rate. The fee calculation engine 4 then calculates 35 a difference 29 between the two and returns 30 the various translation fees to the interface 2. The fee calculation engine 4 checks whether the modified word count is lower than the original word count, for example as part of or after step 23, 24 or 25 and proceeds as described above if the check is positive. If the check is negative, step 26 and step 35 are skipped and step 30 only returns the original translation fee for the relevant source-target language pairs.

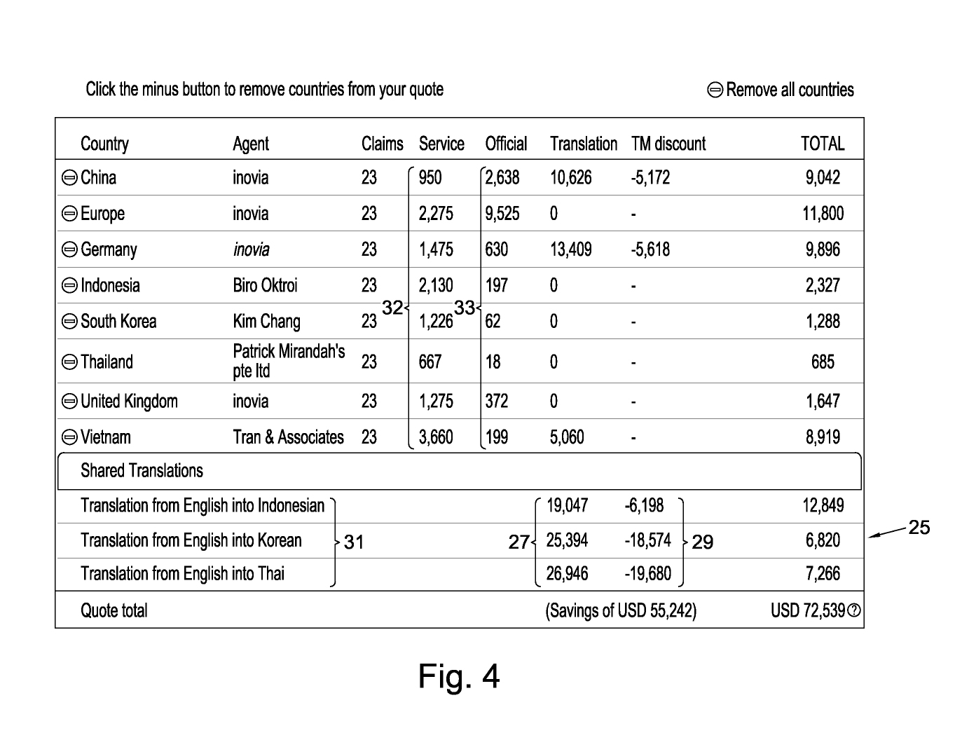

FIG. 4 illustrates a screen shot of the interface 2 in which the original translation fee 27, the modified translation fee 28 and the difference 29 are displayed for a number of language pairs 31.

The screen shot also includes calculated attorney fees 32 and government fees 33 charged by the patent offices. These fees have been calculated by the fee calculation engine taking into account the “specification statistics” such as the numbers of pages, numbers of claims, numbers of priority documents and the like.

In one embodiment the country selections are received at the interface 2 from a user. In alternative embodiments the selections are received from a user preference database which stores the preferred countries the user normally files into.

In some embodiments the translation memory is specific to a particular user, account or company. In that embodiment the interface 2 is designed to receive a user identifier from the user. The translation memory database 5 contains a number of translation memories, each having an associated user identifier, such that when the translation memory analyser compares the original document with previous translations stored in a translation memory database it does so only in respect of those translation memories that are associated with the received user identifier.

The above embodiments have been presented illustratively to assist the addressee understand the structure and function of those embodiments. That addressee will also appreciate, particularly given the benefit of the teaching herein, that various features and functions from the embodiments are selectively available in combination, or are interchangeable or omissible depending upon the specifics of the precise implementation of an embodiment. The intention of the inventors in providing the exemplary embodiments is to demonstrate the implementation of the invention and not to suggest that those features and functions are not able to be added substituted or omitted from other possible embodiments.

Although the invention has been described with reference to specific examples, it will be appreciated by those skilled in the art that the invention may be embodied in many other forms, including but not limited to being embodied as devices, systems and methods.

1. A computer system for automatically calculating translation costs based upon translation memory analysis, the computer system comprising an interface adapted to communicate with a translation memory analyser and a fee calculation engine, wherein
(a) the interface is configured to receive an original document and a source-target language pair;
(b) the translation memory analyser is configured to:
(i) compare the original document with previously translated text portions in the language of the original document stored in a translation memory database corresponding to the source-target language pair; and
(ii) return an original word count and a modified word count reflecting the degree of overlap between the original document and the previously translated text portions;
(c) the fee calculation engine is configured to:
(i) receive at least the modified word count and the source-target language pair;
(ii) identify a per word translation rate corresponding to the source-target language pair in a fee rule database; and
(iii) calculate a modified translation cost from the per word translation rate and the modified word count.

2. The computer system of claim 1 wherein the fee calculation engine is configured to provide the modified translation cost to the interface which is configured to display the modified translation cost or to transmit the modified translation cost to a client computer.

3. The computer system of claim 1, wherein the fee calculation engine checks whether the modified word count is lower than the original word count, and if this check is negative the fee calculation engine overwrites the modified word count with the original word count.

4. The computer system of claim 1, wherein the interface is further configured to receive a plurality of selected source-target language pairs and wherein the translation memory analyser is configured to generate a modified word count for each language pair and wherein the fee calculation engine is configured to calculate modified translation costs for each language pair.

5. The computer system of claim 1, wherein the original document is a patent specification and wherein each selected language pair corresponds to a selected patent jurisdiction,
and wherein the fee calculation engine is further configured to calculate attorney fees and government fees for filing the patent specification in the selected patent jurisdiction.

6. The computer system of claim 5, wherein each language pair is selected automatically on the basis of the selected patent jurisdiction.

7. The computer system of claim 5, wherein the interface is adapted to receive the selected patent jurisdictions from:
(a) a user; or
(b) a list of preselected patent jurisdictions stored in a user preference database.

8. The computer system of claim 1, wherein the interface is further adapted to receive a user identifier and wherein the translation memory database contains a plurality of translation memories, each having an associated user identifier, such that when the translation memory analyser compares the original document with previously translated text stored in a translation memory database it does so only in respect of those translation memories that are associated with the received user identifier.

9. A computer-implemented method of automatically calculating translation costs based upon translation memory analysis, the method comprising:
receiving an original document and a source-target language pair;
comparing the original document with previously translated text portions in the language of the original document stored in a translation memory database corresponding to the source-target language pair;
computing a modified word count reflecting the degree of overlap between the original document and the previously translated text portions based on the comparison;
identifying a per word translation rate corresponding to the source-target language pair in a fee rule database; and
calculating a modified translation cost from the per word translation rate and the modified word count.

10. The method of claim 9 wherein the method comprises providing the modified translation cost to an interface which is configured to display the modified translation cost or to transmit the modified translation cost to a client computer.

11. The method of claim 9, wherein the method comprises checking whether the modified word count is lower than an original word count, and if this check is negative overwriting the modified word count with the original word count.

12. The method of claim 9, wherein the method comprises receiving a plurality of selected source-target language pairs, generating a modified word count for each language pair and calculating modified translation costs for each language pair.

13. The method of claim 9, wherein the original document is a patent specification and wherein each selected language pair corresponds to a selected patent jurisdiction,
and wherein the method further comprises calculating attorney fees and government fees for filing the patent specification in the selected patent jurisdiction.

14. The method of claim 13, wherein each language pair is selected automatically on the basis of the selected patent jurisdiction.

15. The method of claim 13, wherein the method comprises receiving the selected patent jurisdictions from:
(a) a user; or
(b) a list of preselected patent jurisdictions stored in a user preference database.

16. The method of claim 9, wherein the translation memory database contains a plurality of translation memories, each having an associated user identifier, wherein the method comprises receiving a user identifier, and wherein comparing the original document with previous translations stored in the translation memory database comprises comparing the original document with previously translated text stored in translation memories that are associated with the received user identifier.

17. A computer program product comprising coded instructions that, when executed on a processor, implement a method as claimed in claim 9.

18. A tangible computer-readable medium embodying a computer program product as claimed in claim 17.

19. A carrier signal encoding a computer program product as claimed in claim 17.

20. A computer system comprising a processor configured to implement a method as claimed in claim 9.

21. (canceled)
